(19) United States
(12) Patent Application Publication
(10) Pub. No.: US 2014/0136597 A1
(43) Pub. Date: May 15, 2014

(54) RELAY ENABLED DYNAMIC VIRTUAL PRIVATE NETWORK

(71) Applicants: Loren Lanier Bland, San Francisco, CA (US); George Runcie, San Jose, CA (US)

(72) Inventors: Loren Lanier Bland, San Francisco, CA (US); George Runcie, San Jose, CA (US)

(73) Assignee: KASEYA INTERNATIONAL LIMITED, St. Helier (JE)

(21) Appl. No.: 13/677,604

(22) Filed: Nov. 15, 2012

(51) Int. Cl. G06F 15/16

(52) U.S. Cl. 709/203

(57) ABSTRACT

A method and apparatus are disclosed for configuring a virtual private network (VPN). One example method of operation may include receiving a request from a client computing device to connect to a VPN device. The method may also include identifying at least one candidate VPN device based on a predetermined criteria, assigning the at least one candidate VPN device as a VPN server, and establishing a communication link between the client computing device and the VPN server on a remote network.

### TECHNICAL FIELD

The present application is generally related to a virtual private network device configuration, and more particularly, to a dynamic remote access system that identifies and designates a VPN device for VPN access to a client computing machine.

### BACKGROUND

Conventionally, a user machine accessing a virtual private network (VPN) may establish a connection with a VPN server across a network (i.e., a local area network (LAN), wide area network (WAN), the Internet, etc.).

The traditional VPN configuration is illustrated in the network configuration of FIG. 1. For example, in FIG. 1 a network 100 includes a client computer 124 which establishes a connection to a known VPN server 122 operating in a remote network 120. In operation, the client computer 124 may transmit a connection establishment message 110 to a known VPN server 122. The connection establishment message 110 may include a known IP address of the known VPN server 122.

A browser application may be used to connect to the VPN server 122 and then initiate a local process 112 (i.e., VPN client 126) which is part of the client computer 124. The VPN client 126 may then establish a connection 114 with the VPN server 122. Once a connection is established the user of the client computer 124 can access the resources offered by the VPN on the remote network 120.

Static VPN servers are limited to providing a designated remote access function with limited flexibility to provide other functions. A virtual systems administrator (VSA) may offer setup and provisioning services to setup any machine connecting to the VSA. The VSA could be used to dynamically setup any computer as a VPN server. Such a configuration provides network resources on any network accessible by a remote computing device to be dynamically setup for remote access by the remote computing device.

### SUMMARY

One example embodiment provides an example method of configuring a virtual private network (VPN). The method may include receiving a request from a client computing device to connect to a VPN device and identifying at least one candidate VPN device based on a predetermined criteria. The method may also include assigning the at least one candidate VPN device as a VPN server and establishing a communication link between the client computing device and the VPN server on a remote network.

Another example embodiment may also include an apparatus configured to setup a virtual private network (VPN). The apparatus may include a receiver configured to receive a request from a client computing device to connect to a VPN device. The apparatus may also include a processor configured to identify at least one candidate VPN device based on a predetermined criteria, and assign the at least one candidate VPN device as a VPN server. The apparatus may also include a transmitter configured to transmit a communication link message to establish a link between the client computing device and the VPN server on a remote network.

### BRIEF DESCRIPTION OF THE DRAWINGS

FIG. 1 illustrates an example conventional VPN access network.

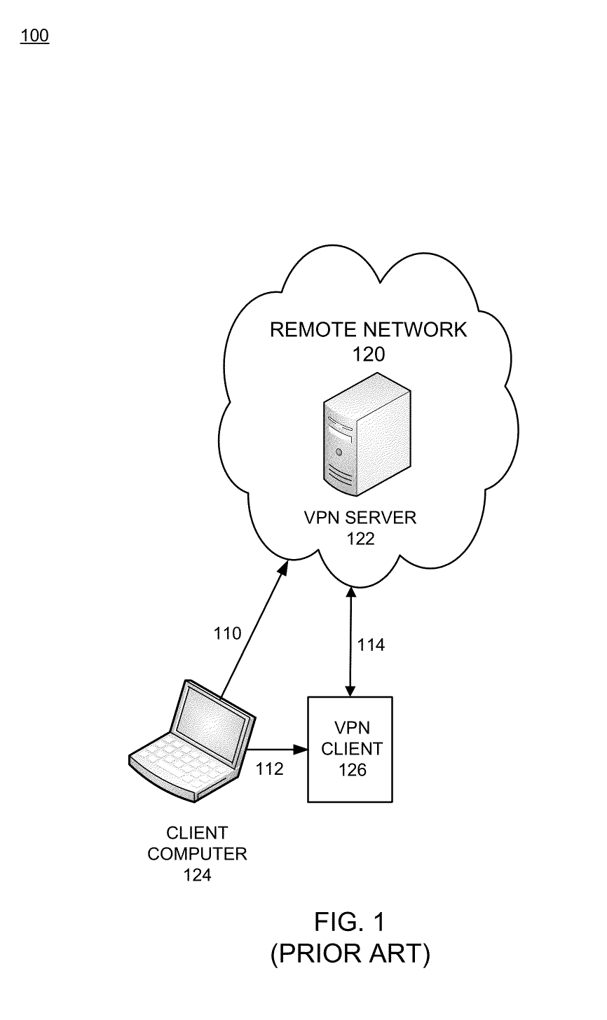

FIG. 2 illustrates an example communication network configured to setup a relay connection according to example embodiments.

FIG. 3 illustrates an example communication network including a virtual systems administrator (VSA) used to setup a dynamic VPN according to example embodiments.

FIG. 4 illustrates an example system entity that performs one or more of the VPN setup configurations according to example embodiments.

FIG. 5 illustrates an example network entity configured to store instructions and processing hardware for performing operations according to example embodiments.

FIG. 6 illustrates an example flow diagram method of operation according to example embodiments.

### DETAILED DESCRIPTION

It will be readily understood that the components of the application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

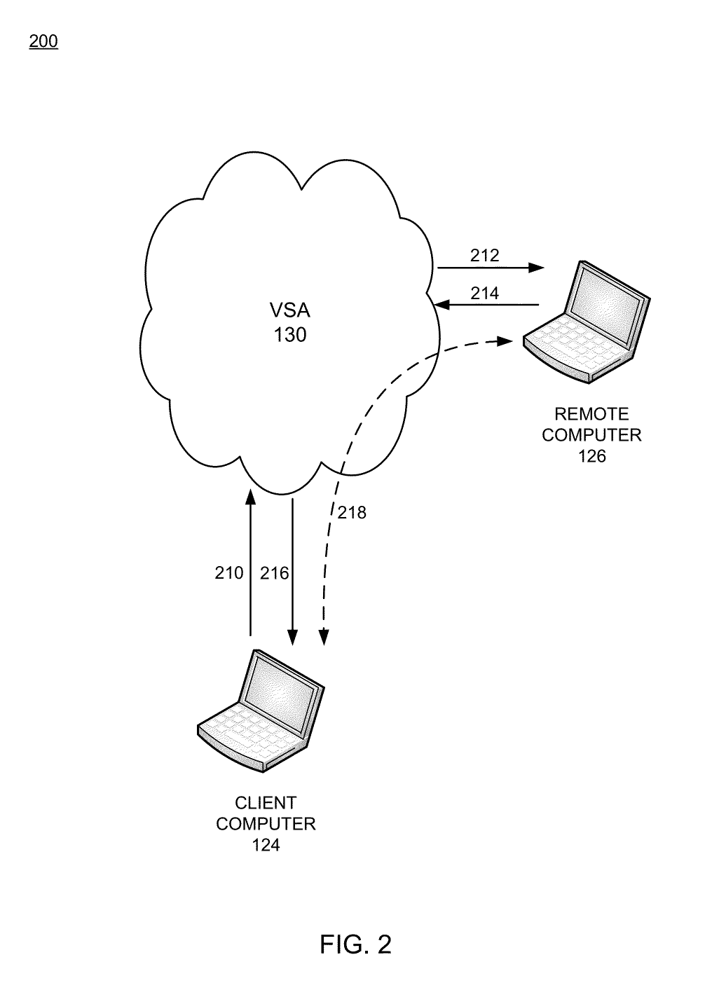

Example embodiments provide a relay connection establishment, a virtual private network (VPN) connection and service establishment and/or a virtual systems administrator (VSA) connection and service establishment. FIG. 2 illustrates an example communication network with a relay connection establishment configuration. Referring to FIG. 2, the network configuration 200 includes a client computer or user computer 124 that is attempting to access a remote computer 126, which may be a desktop, laptop, mobile station, server, database or other computing device.

The VSA 130 may be a network portal, browser or other communication medium or device that is used to establish a connection from the client computer 124 to a remote computer 126. The virtual system administrator (VSA) may be an interface-based website that is accessible via a user terminal computer or other user interface device. The VSA interface is a functional interface that may be used to perform operations and functions and control program execution.

In order to establish a relay enabled dynamic VPN, a relay connection must be established. First, a browser portal or other user interface application may be used by a user of the client computer 124 to connect to the VSA and launch a live connect session 210 to any available agent or corresponding application. Next, a script may be executed on the agent device 212 (i.e., remote computer 126) specifying a session between the browser of the client computer 124 and the remote machine session to communicate through the VSA relay across the network cloud 130. The user browser then connects to the relay by transmitting a session identifier (ID) to the VSA 130. As a result, the browser may be capable of communicating to the remote machine 126 directly through the VSA relay 130. The remote machine 126 may confirm the relay connection 214 to the VSA 130 and to the client computer 124 via forwarding message 216. The relay 218 may be established and maintained for the remainder of the session. Once the relay connection of FIG. 2 is setup a VPN server may be identified and provisioned on-the-fly via a dynamic provisioning operation.

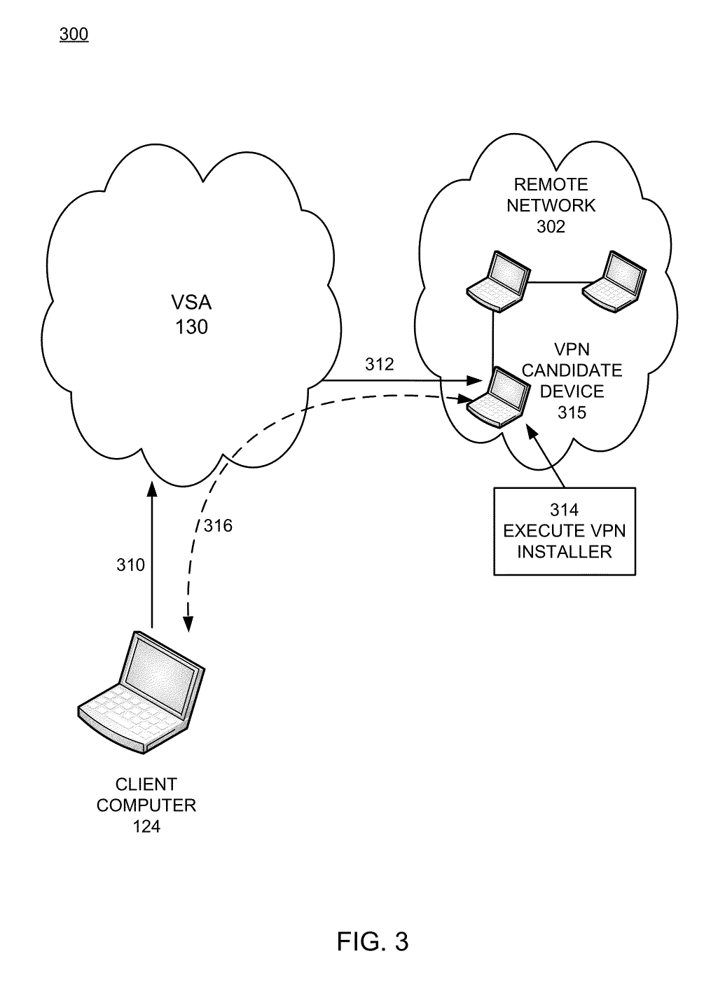

FIG. 3 illustrates an example communication network and corresponding VPN server provisioning operation according to example embodiments. Referring to FIG. 3, the client computer 124 may access the VSA 130 via a browser interface. The client computer 124 may transmit a communication request 310 to the VSA 130 requesting that a remote machine operating on the remote network 302 should be configured as a VPN server. The VSA 130 may relay the request message 312 to the remote network 302. The VSA 130 may also transmit a server install procedure, software and/or instructions to the VPN candidate device 315. The VSA may invoke a VPN server install procedure that includes setting up a secure socket to begin the uploading of the install executable to the candidate VPN server 315.

The candidate VPN server 315 may receive, process and automatically execute the VPN installer and configure the installer for a connection to a requesting entity (i.e., the client computer 124). On the client computer device 124, the browser may initiate a VPN client external to the browser that establishes a connection to the remote VPN server 315. The VPN client application can be executed within the browser of the user interface as well. The remote browser of the client machine 124 may now access all the network resources of the remote network 302.

As indicated above, any of the devices, machines, etc., may be candidates for the new VPN server assignment process. The VSA service provides a way to setup the next VPN server dynamically, such as a new device that has not yet been designated as a VPN server. This dynamic approach to VPN setup on-the-fly offers flexibility with network machines, resources, access methods, etc. The user device or client computer 124 may include any computing device. The device may be a computer, laptop, mobile, wireless or cellular phone, a PDA, a tablet, a client a server or any device that contains a processor and/or memory, whether that processor or memory performs a function related to an example embodiment.

Referring again to FIG. 3, the VPN device selection operation may include designating a device that is on a particular subnet of resources, a database computer, a printer computer, a specific application computer, an available computer, etc. In operation, the client computing device 124 may transmit a message requesting access to a VPN device on the remote network 302, even though no VPN server/device has yet been designated. The message may include an indicator that specifies a particular service, network segment, application, etc. of interest to the client computing device 124. The indicator may invoke the VSA service 130 to identify a list of known devices which are available and which qualify for one or more of the above-noted indicators included in the request for access to a VPN server. The VSA 130 may then query those devices that match the criteria and identify which one is most available or is not currently operating above a specified service threshold (e.g., memory usage, CPU usage, storage capabilities, etc.) and select that device as the candidate VPN server.

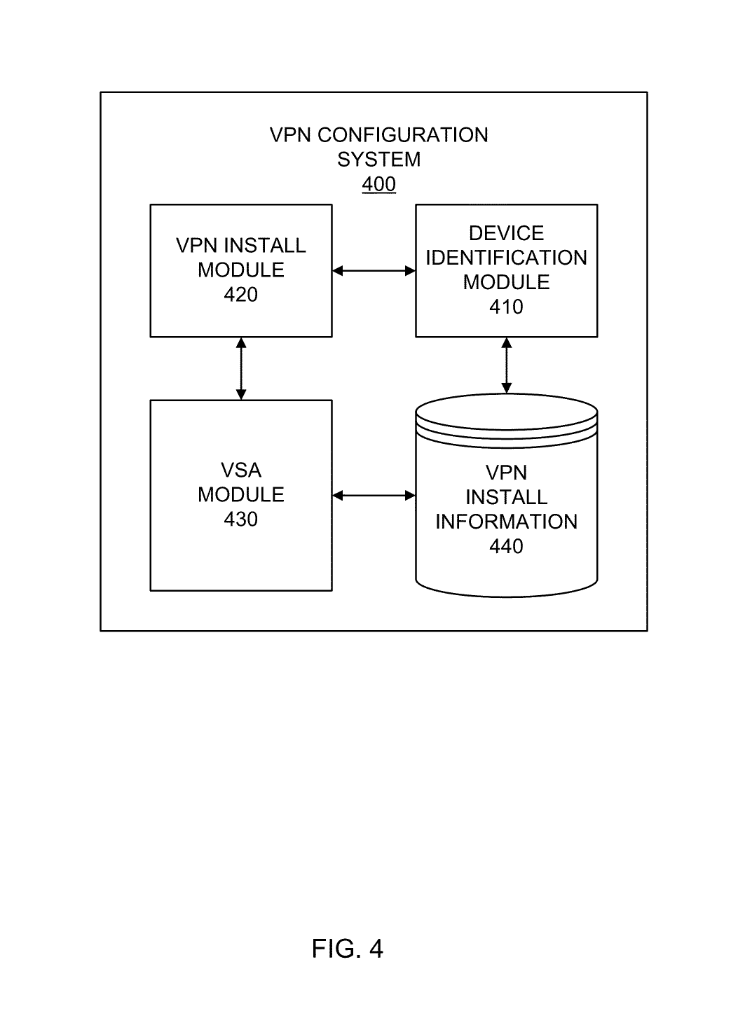

FIG. 4 illustrates an example VPN configuration system 400 according to example embodiments. Referring to FIG. 4, the system 400 may provide a method of configuring a virtual private network (VPN). The example method performed by the system 400 may include receiving a request from a client computing device to connect to a VPN device. The request may be received by the device identification module 410, which identifies the requesting device and identifies one or more candidate VPN devices based on a predetermined criteria factor. The VPN install module 420 may assign the candidate VPN device as a VPN server assuming the predetermined criteria factor is satisfied by the selected candidate VPN device. The VPN install information may be retrieved from the database 440 and forwarded to the new VPN server. Next, a VSA module 430 may establish a communication link between the client computing device and the VPN server operating on a remote network.

The candidate VPN device may be assigned as the VPN server after the request from the client computing device is received. In other words, the VPN device may be unknown when the request is received, and may be subsequently identified, selected and designated as the new VPN server after the request is received. The VSA module 430 may also provide access to a plurality of computing devices on the remote network shared by the VPN server after the VPN server is designated as the new VPN server.

The request may be received from a client browser application operating on the client computing device. The system 400 may also provide identifying the candidate VPN device as operating on a particular subnet and providing access to at least one predetermined application. The system 400 may also include comparing the predetermined criteria to at least one of the particular subnet and the at least one predetermined application, and selecting the at least one candidate VPN device to be the VPN server based on at least one positive match resulting from the comparing operation. The predetermined application may be at least one of a database application and a network resource application. Also, the candidate VPN device is identified from a list of known devices which are available and which include the at least one predetermined criteria.

Example embodiments are preferably realized in a hardware device, such as, a server, computer, cellular phone, or other mobile terminal device etc. In other embodiments, the present application may be realized in hardware, software, firmware or a combination of hardware, software and/or firmware. The above example embodiments may also be implemented in software code and may be stored on a computer readable medium, such as, for example, non-volatile memory devices (e.g., RAM, ROM, hard disk etc.). The software code may be accessed from a non-transitory computer readable medium and may be executed by a processor. The executed program may provide one or more of the features of the example embodiments. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

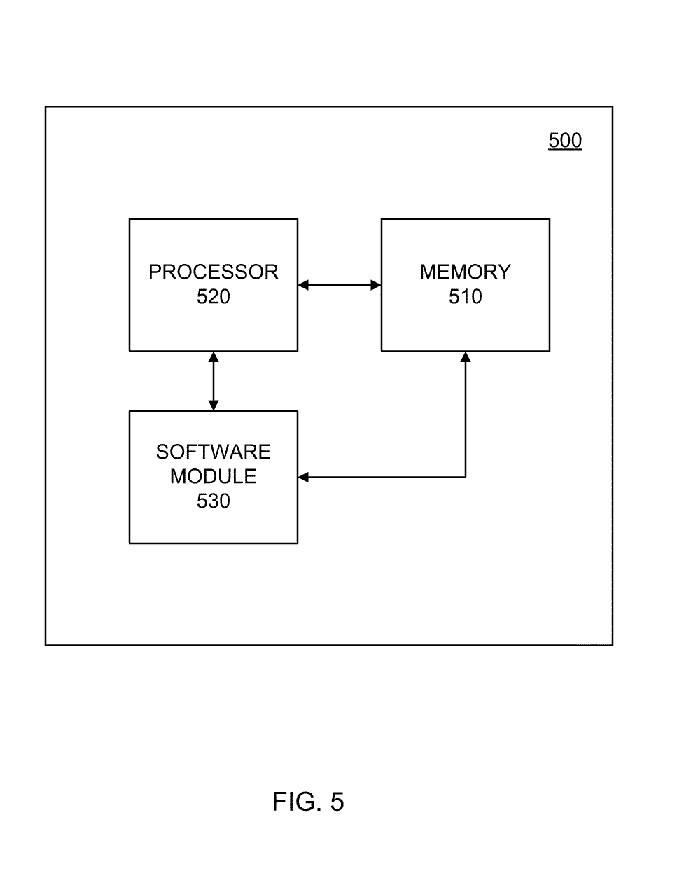

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example FIG. 5 illustrates an example network element 500, which may represent any of the above-described network components of the other figures.

As illustrated in FIG. 5, a memory 510 and a processor 520 may be discrete components of the network entity 500 that are used to execute an application or set of operations. The application may be coded in software in a computer language understood by the processor 520, and stored in a computer readable medium, such as, the memory 510. The computer readable medium may be a non-transitory computer readable medium that includes tangible hardware components in addition to software stored in memory. Furthermore, a software module 530 may be another discrete entity that is part of the network entity 500, and which contains software instructions that may be executed by the processor 520. In addition to the above noted components of the network entity 500, the network entity 500 may also have a transmitter and receiver pair configured to receive and transmit communication signals (not shown).

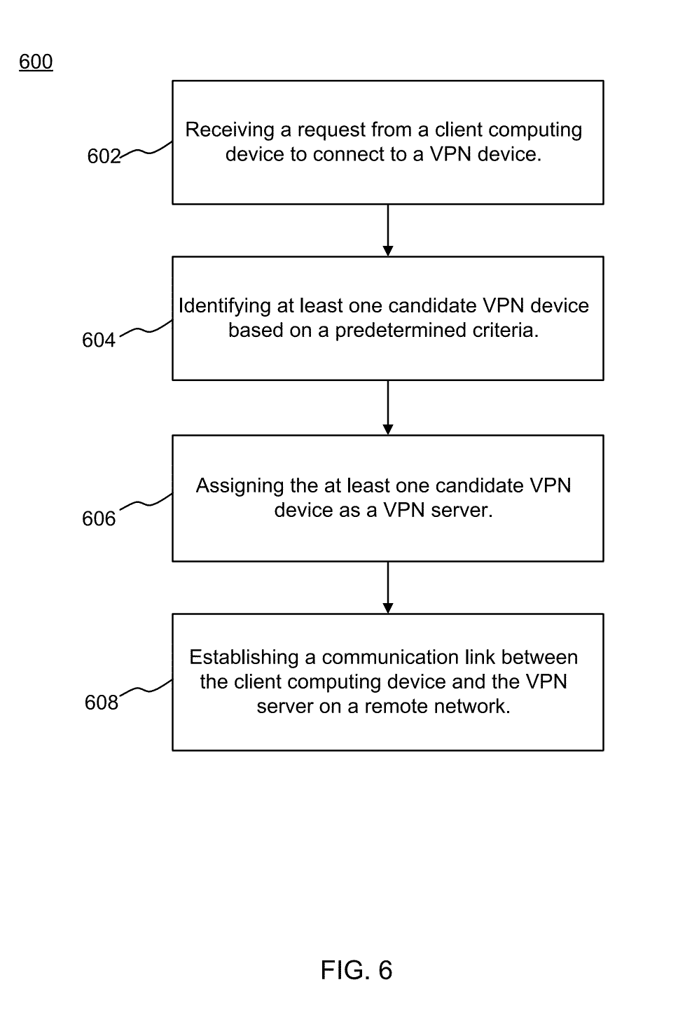

FIG. 6 illustrates an example method of operation according to example embodiments. Referring to FIG. 6, the method 600 may include a configuring a virtual private network (VPN). The method may provide receiving a request from a client computing device to connect to a VPN device at operation 602 and identifying at least one candidate VPN device based on a predetermined criteria at operation 604. The method may also include assigning the at least one candidate VPN device as a VPN server at operation 606, and establishing a communication link between the client computing device and the VPN server on a remote network at operation 608.

Although an exemplary embodiment of the system, method, and computer readable medium of the present application has been illustrated in the accompanied drawings and described in the foregoing detailed description, it will be understood that the application is not limited to the embodiments disclosed, but is capable of numerous rearrangements, modifications, and substitutions without departing from the spirit or scope of the application as set forth and defined by the following claims. For example, the capabilities of the systems described herein can be performed by one or more of the modules or components described herein or in a distributed architecture. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

It is to be understood that the above description is intended to be illustrative, and not restrictive. Many other embodiments will be apparent to those of skill in the art upon reading and understanding the above description. Although the present application has been described with reference to specific exemplary embodiments, it will be recognized that the application is not limited to the embodiments described, but can be practiced with modification and alteration within the spirit and scope of the appended claims. Accordingly, the specification and drawings are to be regarded in an illustrative sense rather than a restrictive sense. The scope of the application should, therefore, be determined with reference to the appended claims, along with the full scope of equivalents to which such claims are entitled.

What is claimed is:

1. A method of configuring a virtual private network (VPN), the method comprising:
receiving a request from a client computing device to connect to a VPN device;
identifying at least one candidate VPN device based on a predetermined criteria;
assigning the at least one candidate VPN device as a VPN server; and
establishing a communication link between the client computing device and the VPN server on a remote network.

2. The method of claim 1, wherein the at least one candidate VPN device is assigned as the VPN server after the request from the client computing device is received.

3. The method of claim 1, further comprising:
providing access to a plurality of computing devices on the remote network shared by the VPN server.

4. The method of claim 1, wherein the request is received from a client browser application operating on the client computing device.

5. The method of claim 1, further comprising:
identifying the at least one candidate VPN device as operating on a particular subnet and providing access to at least one predetermined application;
comparing the predetermined criteria to at least one of the particular subnet and the at least one predetermined application; and
selecting the at least one candidate VPN device to be the VPN server based on at least one positive match resulting from the comparing operation.

6. The method of claim 5, wherein the at least one predetermined application comprises at least one of a database application and a network resource application.

7. The method of claim 6, wherein the at least one candidate VPN device is identified from a list of known devices which are available and which comprise the at least one predetermined criteria.

8. An apparatus configured to setup a virtual private network (VPN), the apparatus comprising:
a receiver configured to receive a request from a client computing device to connect to a VPN device;
a processor configured to
identify at least one candidate VPN device based on a predetermined criteria,
assign the at least one candidate VPN device as a VPN server; and
a transmitter configured to transmit a communication link message to establish a link between the client computing device and the VPN server on a remote network.

9. The apparatus of claim 8, wherein the at least one candidate VPN device is assigned as the VPN server after the request from the client computing device is received.

10. The apparatus of claim 8, wherein the processor is further configured to provide access to a plurality of computing devices on the remote network shared by the VPN server.

11. The apparatus of claim 8, wherein the request is received from a client browser application operating on the client computing device.

12. The apparatus of claim 8, wherein the processor is further configured to
identify the at least one candidate VPN device as operating on a particular subnet and provide access to at least one predetermined application,
compare the predetermined criteria to at least one of the particular subnet and the at least one predetermined application, and
select the at least one candidate VPN device to be the VPN server based on at least one positive match resulting from the comparison.

13. The apparatus of claim 12, wherein the at least one predetermined application comprises at least one of a database application and a network resource application.

14. The apparatus of claim 13, wherein the at least one candidate VPN device is identified from a list of known devices which are available and which comprise the at least one predetermined criteria.

15. A non-transitory computer readable storage medium configured to store instructions that when executed cause a processor to perform configuring a virtual private network (VPN), the processor being further configured to perform:
receiving a request from a client computing device to connect to a VPN device;
identifying at least one candidate VPN device based on a predetermined criteria;
assigning the at least one candidate VPN device as a VPN server; and
establishing a communication link between the client computing device and the VPN server on a remote network.

16. The non-transitory computer readable storage medium of claim 15, wherein the at least one candidate VPN device is assigned as the VPN server after the request from the client computing device is received.

17. The non-transitory computer readable storage medium of claim 15, wherein the processor is further configured to perform:
providing access to a plurality of computing devices on the remote network shared by the VPN server.

18. The non-transitory computer readable storage medium of claim 15, wherein the request is received from a client browser application operating on the client computing device.

19. The non-transitory computer readable storage medium of claim 15, wherein the processor is further configured to perform:
identifying the at least one candidate VPN device as operating on a particular subnet and providing access to at least one predetermined application;
comparing the predetermined criteria to at least one of the particular subnet and the at least one predetermined application; and
selecting the at least one candidate VPN device to be the VPN server based on at least one positive match resulting from the comparing operation.

20. The non-transitory computer readable storage medium of claim 19, wherein the at least one predetermined application comprises at least one of a database application and a network resource application, and wherein the at least one candidate VPN device is identified from a list of known devices which are available and which comprise the at least one predetermined criteria.
